(19) United States
(12) Patent Application Publication
(10) Pub. No.: US 2007/0078776 A1
(43) Pub. Date: Apr. 5, 2007

(54) Code-generating method for authorization identification and authorization identification and management system

(76) Inventor: Jung-Bang Wang, Linkou Township (TW)

Correspondence Address: TROXELL LAW OFFICE PLLC;SUITE 1404, 5205 LEESBURG PIKE, FALLS CHURCH, VA, 22041, US

(21) Appl. No.: 11/521,455

(22) Filed: Sep. 15, 2006

(30) Foreign Application Priority Data
Sep. 16, 2005 (TW) 094132103

(51) Int. Cl. G06Q 99/00

(52) U.S. Cl. 705/59

(57) ABSTRACT

An authorization identification and management system includes a License Code/Royalty Code generating unit, an authorization code database and an audit unit. The License Code/Royalty Code generating unit is used to provide a plurality of sets of License Code generated according to different products of a right holder and a plurality of sets of Royalty Code generated according to different licensees. A set of License code is combined with a corresponding set of Royalty code for generating a set of single legal authorization code (License Code+Royalty Code) for arranging on a product. The audit unit is used to recognize the set of single legal authorization code arranged on the product and compare it with one downloaded from the authorization code database to judge whether the two sets are identical.

### BACKGROUND OF THE INVENTION

1. Field of the Invention

The present invention relates to a code-generating method for authorization identification and authorization identification and management system and, more particularly, to a authorization identification and management system, where a set of single legal authorization code (License Code+Royalty Code) is generated by combining a set of License Code generated according to different products of a right holder with a set of Royalty Code generated according to different licensees. And then by arranging the set of single legal authorization code on a product, the system can effectively authorize the product (and also can make the product anti-counterfeit) and calculate the amount of royalty fees.

2. Description of the Prior Art

A product that has been legally authorized needs to meet two conditions, including (1) the product has been authorized to allow manufacturing, and (2) an authorized person has paid royalty fees for the product. However, under the lure of benefit, a lot of illegal manufacturers produce many products that encroach upon the legal rights of a patent holder. Also, some manufacturers that have obtained a license to manufacture a product utilize the license to cover up illegal behavior and evade paying royalty fees to the right holder. These encroachments upon licensed products have made the normal market circulation of commodities suffer greatly, especially authorized persons that have spent a large amount of manpower and financial resources in creating a fine brand. Moreover, because of the progress and development of science and technology, counterfeiters can often easily produce something that is faked but looks like the authentic article. Hence, a lot of anti-falsification technology is actually useless in identifying whether an article is authentic or not.

In order to solve the problem of products being counterfeited, it is important to improve anti-falsification technology. Many kinds of anti-counterfeit tags have already been disclosed in prior art, such as laser holographs, fluorescent ink, or variable ink, etc. However, the greatest problem of current anti-falsification technology is that if consumers want to distinguish between authentic and fake goods, they must rely on corresponding equipments or tools to help them make that distinction. As stated, with the development of science and technology, counterfeiters can make anti-counterfeit tags that are faked but look authentic. Therefore, it is difficult to stop imitations and the encroachment upon licensed products.

Moreover, in regard to current anti-counterfeit methods, some people arrange digital data or bar codes on a product via etching or printing methods. Other people arrange digital data behind an anti-counterfeit tag and then attach the anti-counterfeit tag on the product. Hence, anyone can read the anti-counterfeit tag that is arranged on the product or the packaging of the product, either by simply looking at it, or by using a reader, to judge whether the product is authentic or fake and whether the product manufacturer has obtained a license or not. However, the above-mentioned current anti-counterfeit methods can only distinguish whether the product in question is licensed or not. They are unable to calculate the total number of products that have been manufactured and sold for the right holder to audit. Moreover, there are some shortcomings in the prior art, such as it is usually difficult for people other than the right holder or an authorized person to distinguish between authentic or fake products simply by examining the anti-counterfeit tags, and the anti-counterfeit tags themselves are expensive to manufacture and purchase.

Thus, it is obvious to find some shortcomings that should be improved in the use of anti-counterfeit tags or other methods for anti-counterfeit. And the present invention is designed to effectively solve the problems mentioned above.

### SUMMARY OF THE INVENTION

The main objective of the present invention is to generate a set of single legal authorization code (License Code+Royalty Code) and arrange it on a product by which the present invention can effectively authorize the product and calculate the amount of royalty fees. The set of single legal authorization code is generated by combining a set of License Code generated according to different products of a right holder with a set of Royalty Code generated according to different licensees.

That is to say, a right holder can establish sets of License Code corresponding to different products in a database beforehand according to his own products so as to authorize a licensee to manufacture the products and calculate the amount of royalty fees simultaneously. Moreover, when wanting to sell a manufactured product, the licensee can ask for a set of Royalty Code through the Internet or other means and at this time the right holder will provide a set of single legal authorization code for the licensee to arrange it on the product so that the legal authorization is completed and the product can be sold. Thereby, via the set of single legal authorization code, the right holder can receive the royalty fees and make the product anti-counterfeit.

In order to achieve the above objectives, the present invention provides a code-generating method comprising a series of steps. First, it provides a plurality of sets of License Code generated according to different products of a right holder and a plurality of sets of Royalty Code generated according to different licensees, wherein each set of License Code at least includes a product code for classifying different products and each set of Royalty Code at least includes a licensee code for classifying different licensees. Then, each set of License Code is combined with the corresponding set of Royalty Code. Finally, each set of License Code is combined with each corresponding set of Royalty Code for generating a plurality of sets of single legal authorization code.

Besides, in order to achieve the above objectives, the present invention also provides an authorization identification and management system comprising a License Code/Royalty Code generating unit, an authorization code database and an audit unit. The License Code/Royalty Code generating unit provides a plurality of sets of License Code generated according to different products of a right holder and a plurality of sets of Royalty Code generated according to different licensees, wherein each set of License Code at least includes a product code for classifying different products and each set of Royalty Code at least includes a licensee code for classifying different licensees. Moreover, each set of License Code has a corresponding set of Royalty Code and each set of License Code is combined with the corresponding set of Royalty Code for generating a set of single legal authorization code.

Furthermore, the authorization code database is used to store the sets of single legal authorization code that have been authorized to the licensees so as to manage the number of the products legally authorized. The audit unit is used to recognize the set of single legal authorization code arranged on a product and compare it with one downloaded from the authorization code database to judge whether the two sets are identical.

In addition, each set of License Code includes a product code for classifying different products and a random control code for calculating the number of different products, and each product code corresponds to a royalty rate. And each set of Royalty Code includes a licensee code for classifying different licensees and a random control code for calculating the number of different licensees. It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The technical features, means and advantages of the present invention will be more readily understood from the following detailed description when read in conjunction with the appended drawings, in which:

FIG. 1 is a function block diagram of an authorization identification and management system according to the present invention;

FIG. 2 is a code-generating schematic view of a set of License Code and a set of Royalty Code according to the present invention; and

FIG. 3 is a flowchart of a code-generating method for authorization identification according to the present invention.

### DETAILED DESCRIPTION OF THE PREFERRED EMBODIMENT

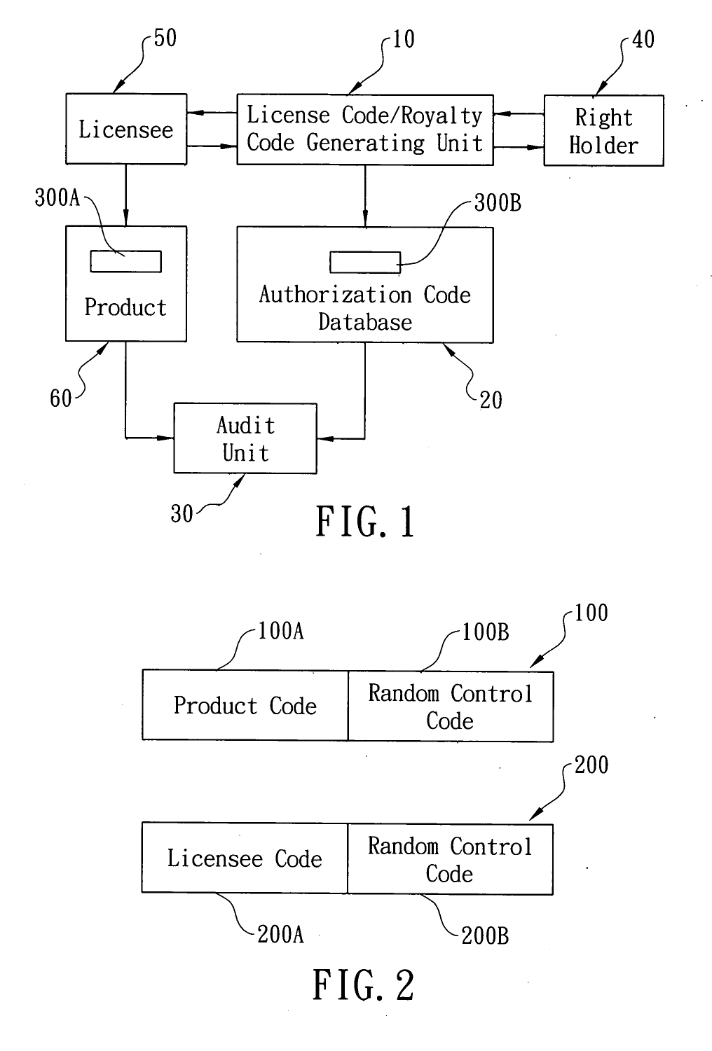

FIG. 1 shows a function block diagram of an authorization identification and management system according to the present invention and FIG. 2 shows a code-generating schematic view of a set of License Code and a set of Royalty Code according to the present invention. In FIG. 1, the present invention provides an authorization identification and management system comprising a License Code/Royalty Code generating unit 10, an authorization code database 20 and an audit unit 30.

The License Code/Royalty Code generating unit 10 is used to provide a plurality of sets of License Code generated according to different products of a right holder 40 and a plurality of sets of Royalty Code generated according to different licensees 50, wherein the sets of License Code and the sets of Royalty Code are pre-set by the right holder 40 under the condition mentioned above. Besides, as shown in FIG. 2, each set of License Code 100 includes a product code 100A for classifying different products and a random control code 100B for calculating the number of different products, and each product code belonging to a different product corresponds to a royalty rate. Moreover, each set of Royalty Code 200 includes a licensee code 200A for classifying different licensees 50 and a random control code 200B for calculating the number of products manufactured by different licensees 50.

Furthermore, each set of License Code 100 has a corresponding set of Royalty Code 200 and the set of License Code 100 is combined with the corresponding set of Royalty Code 200 for generating a set of single legal authorization code (License Code+Royalty Code) 300A arranged on a product 60. That is to say, each set of single legal authorization code 300A is arranged on the corresponding product 60 according to different products of a right holder 40 and different licensees 50. Thus, a legally authorized state is confirmed via the single legal authorization code.

In addition, the authorization code database 20 is used to store the sets of single legal authorization code 300B that have been authorized to the licensees so as to manage the number of the products legally authorized. And the audit unit 30 is used to recognize the set of single legal authorization code 300A on the product 60 to judge whether the product is legally authorized. Moreover, there are some auditing methods as following:

(1) The audit unit 30 is a wireless reader with product auditing/comparing program for scanning the set of single legal authorization code 300A that is arranged on the corresponding product 60;

(2) The audit unit 30 is an manually-keying auditing/comparing device with a product auditing/comparing program, and the set of single legal authorization code 300A arranged on the corresponding product 60 is manually keyed-in into the auditing/comparing device; and

(3) The audit unit 30 is a computer that communicates with the authorization code database 20 through the Internet so that an auditor can use the computer to audit and compare two sets of single legal authorization code by Internet access.

Hence, by means of the above-mentioned three auditing methods, the present invention can judge whether the set of single legal authorization code 300A arranged on the corresponding product 60 is the same as the set of single legal authorization code 300B downloaded from the authorization code database 20, or whether the set of License Code 100 and the set of Royalty Code 200 of the set of single legal authorization code 300A correspond.

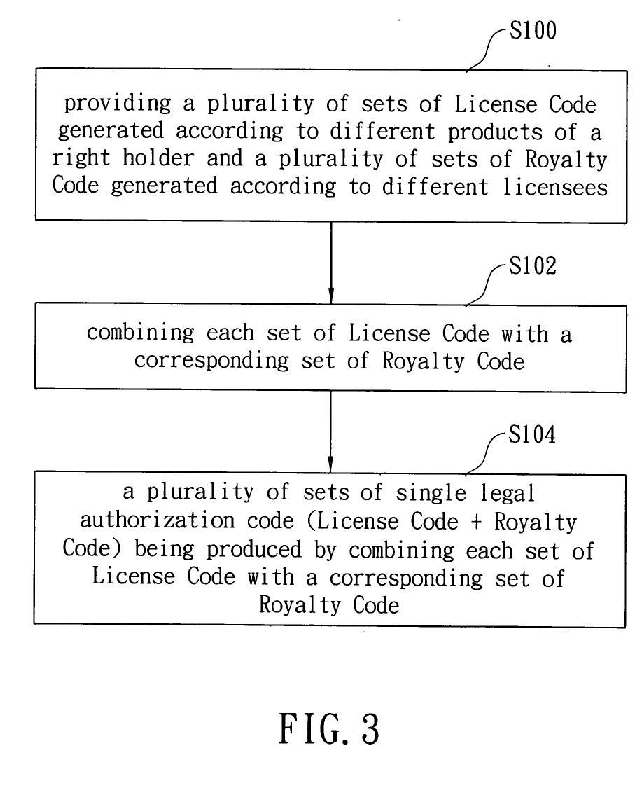

FIG. 3 shows a flowchart of a code-generating method for authorization identification according to the present invention. Referring to FIG. 3, the present invention provides a code-generating method comprising steps of: first, providing a plurality of sets of License Code generated according to different products of a right holder and a plurality of sets of Royalty Code generated according to different licensees (S100), wherein each set of License Code includes a product code for classifying different products and a random control code for calculating the number of different products, and each product code belonging to a different product corresponds to a royalty rate, where this correspondence, however, is not used to limit the present invention. In addition, each set of Royalty Code includes a licensee code for classifying different licensees and a random control code for calculating the number of the products manufactured by different licensees.

Then, each set of License Code is combined with a corresponding set of Royalty Code (S102). Finally, a plurality of sets of single legal authorization code is generated by combining each set of License Code with a corresponding set of Royalty Code (S104), and each set of single legal authorization code is arranged on a corresponding product according to different products of a right holder and different licensees. Thus, a legally authorized state is confirmed via the set of single legal authorization code.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are regarded to be within the scope of the invention as defined in the appended claims.

What is claimed is:

1. A code-generating method for authorization identification, comprising a series of steps of:
providing a plurality of sets of License Code generated according to different products of a right holder and a plurality of sets of Royalty Code generated according to different licensees, wherein each set of License Code at least includes a product code for classifying different products and each set of Royalty Code at least includes a licensee code for classifying different licensees;
combining each set of License Code with the corresponding set of Royalty Code; and
generating a plurality of sets of single legal authorization code (License Code+Royalty Code) by combining each set of License Code with the corresponding set of Royalty Code.

2. The code-generating method for authorization identification as claimed in claim 1, wherein each set of License Code further includes a random control code for calculating the number of different products.

3. The code-generating method for authorization identification as claimed in claim 2, wherein each product code belonging to a different product corresponds to a royalty rate.

4. The code-generating method for authorization identification as claimed in claim 1, wherein each set of Royalty Code further includes a random control code for calculating the number of different licensees.

5. The code-generating method for authorization identification as claimed in claim 1, wherein each set of single legal authorization code is arranged on the corresponding product according to different products of a right holder and different licensees.

6. The code-generating method for authorization identification as claimed in claim 1, wherein a legally authorized state is confirmed via the set of single legal authorization code.

7. An authorization identification and management system, comprising:
a License Code/Royalty Code generating unit, providing a plurality of sets of License Code generated according to different products of a right holder and a plurality of sets of Royalty Code generated according to different licensees, wherein each set of License Code at least includes a product code for classifying different products and each set of Royalty Code at least includes a licensee code for classifying different licensees; each set of License Code has a corresponding set of Royalty Code, and each set of License Code is combined with the corresponding set of Royalty Code for generating a plurality of sets of single legal authorization code;
an authorization code database, for storing the sets of single legal authorization code that have been authorized to the licensees so as to manage the number of the products legally authorized; and
an audit unit, for recognizing the set of single legal authorization code arranged on a corresponding product to judge whether the product is legally authorized.

8. The authorization identification and management system as claimed in claim 7, wherein each set of License Code further includes a random control code for calculating the number of different products.

9. The authorization identification and management system as claimed in claim 8, wherein each product code belonging to a different product corresponds to a royalty rate.

10. The authorization identification and management system as claimed in claim 7, wherein each Royalty Code further includes a random control code for calculating the number of products of different licensees.

11. The authorization identification and management system as claimed in claim 7, wherein the audit unit is a wireless reader with a product auditing/comparing program for judging whether two sets of the single legal authorization code that are respectively arranged on the corresponding product and downloaded from the authorization code database, are the same or not via the wireless reader scanning the sets of single legal authorization code that are arranged on the corresponding products, or judging whether the set of License Code and the set of Royalty Code of the set of single legal authorization code correspond with each other.

12. The authorization identification and management system as claimed in claim 7, wherein the audit unit is a manually-keying auditing/comparing device with a product auditing/comparing program for judging whether each two sets of the single legal authorization code that are respectively arranged on the corresponding product and downloaded from the authorization code database, are the same or not via manually keying-in the sets of single legal authorization code that are arranged on the corresponding products into the auditing/comparing device, or judging whether the set of License Code and the set of Royalty Code of the set of single legal authorization code correspond with each other.

13. The authorization identification and management system as claimed in claim 7, wherein the audit unit is a computer that communicates with the authorization code database through the Internet so that an auditor can judge whether two sets of the single legal authorization code that are respectively arranged on the corresponding product and downloaded from the authorization code database, are the same or not by Internet access, or judge whether the set of License Code and the set of Royalty Code of the set of single legal authorization code correspond with each other.

14. The authorization identification and management system as claimed in claim 7, wherein each set of single legal authorization code is arranged on a corresponding product according to different products of a right holder and different licensees.

15. The authorization identification and management system as claimed in claim 7, wherein a legally authorized state is confirmed via the set of single legal authorization code.
